(19) United States
(12) Patent Application Publication
(10) Pub. No.: US 2017/0207929 A1
(43) Pub. Date: Jul. 20, 2017

(54) Encapsulation Packet With Class Of Service Encoding

(71) Applicant: HEWLETT PACKARD ENTERPRISE DEVELOPMENT LP, Houston, TX (US)

(72) Inventors: Theodore Qian, Palo Alto, CA (US); Xi Huang, Palo Alto, CA (US)

(21) Appl. No.: 15/327,789

(22) PCT Filed: Jul. 31, 2014
(86) PCT No.: PCT/US2014/049287

§ 371 Date: Jan. 20, 2017

(51) Int. Cl. H04L 12/46; H04L 29/08; H04L 12/741

(52) U.S. Cl. CPC H04L 12/4633; H04L 45/74; H04L 12/4641; H04L 67/1097

(57) ABSTRACT

In an example, a technique for integrating Fibre Channel over Ethernet and an overlay network is described herein. A virtual extensible local area network (VXLAN) tunnel endpoint (VTEP) may encode class of service fields in Ethernet frames and encapsulated frames based on class of service fields of inbound and/or outbound messages.

### BACKGROUND

Fibre Channel (FC) is a high-speed network technology capable of running, in some cases, at 2-, 4-, 8- and 16-gigabit per second rates. FC can be used to connect computer data storage, such as storage area networks in enterprise storage. FC signalling can run on an electric interface in addition to fiber-optic cables. A FC protocol is a transport protocol (similar to TCP used in IP networks) that can transport, for example, SCSI commands over FC networks.

Fibre Channel over Ethernet (FCoE) is a computer network technology that encapsulates Fibre Channel frames over Ethernet networks. In some cases, FCoE is used to allow Fibre Channel to use 10 Gigabit Ethernet networks (or higher speeds) while preserving the Fibre Channel protocol.

### BRIEF DESCRIPTION OF DRAWINGS

Examples are described in detail in the following description with reference to implementations shown in the following figures:

FIG. 1 is a system diagram that illustrates a FCoE virtual extensible local area network integrated networking system, according to an example;

FIG. 2 is a block diagram illustrating a computing device that may implement a VTEP, according to an example;

FIG. 3 is a flowchart of a method for imposition of an encapsulated packet, according to an example, according to an example;

FIG. 4 is a block diagram illustrating data flow between the server, the VXLAN network, and the storage network, and modules thereof, according to an example;

FIG. 5 is a flowchart of a method for disposition of an encapsulated packet, according to an example; and

FIG. 6 is a block diagram illustrating data flow between the server, the VXLAN network, and the storage network, and modules thereof, according to an example.

### DETAILED DESCRIPTION

This disclosure discusses, among other things, methods, systems, and computer-readable storage devices that may integrate an FCoE based network and an overlay based cloud network, such as a VXLAN or data center bridging network. An overlay network may be a type of virtual network that is built on top of an underlying physical network. Virtual networks permit virtual devices and/or physical devices to communicate with one another over communication channels that are virtualized onto actual physical communication channels. In much the same way as a given physical computing device can support more than one virtual machine (VM), a physical network may support more than one virtual network. The virtual networks are separated from their underlying physical infrastructure and from one another, such as by using a series of virtual network devices like virtual switches, routers, hubs, and so on, which are virtual versions of their physical counterparts.

FCoE provides facilities for flow control and lossless data transmission. However, these capabilities may be lost, in some cases, if transmitted over an overlay network data through the underlying physical networks on which the overlay networks are implemented. As such, the flow control and lossless data facilities of FCoE, as an example, may be rendered useless.

According to an example, a virtual extensible local area network (VXLAN) tunnel endpoint (VTEP) may receive an Ethernet frame. The Ethernet frame may include a header with a first class of service field. The VTEP may then generate an encapsulated packet. The encapsulated packet may include a header with a second class of service field. The generation of the encapsulated packet may involve the VTEP encoding the second class of service field based on the first class of service field. The VTEP may then transmit the encapsulated packet through a tunnel in a VXLAN network. The VXLAN network may communicate the encapsulated packet according to a class of service lane specified by the second class of service field.

In another example, a VTEP may receive an encapsulated packet from a tunnel in a VXLAN network. The encapsulated packet may include a header with a first class of service field. The VTEP may then update the Ethernet frame. The updated Ethernet frame including a header with a second class of service field. The VTEP may update the Ethernet frame by encoding the second class of service field based on the first class of service field. The VTEP may then transmit the Ethernet frame to a storage network. The storage network may provide lossless communication via a class of service lane specified by the second class of service field.

These and other examples are now described in greater detail.

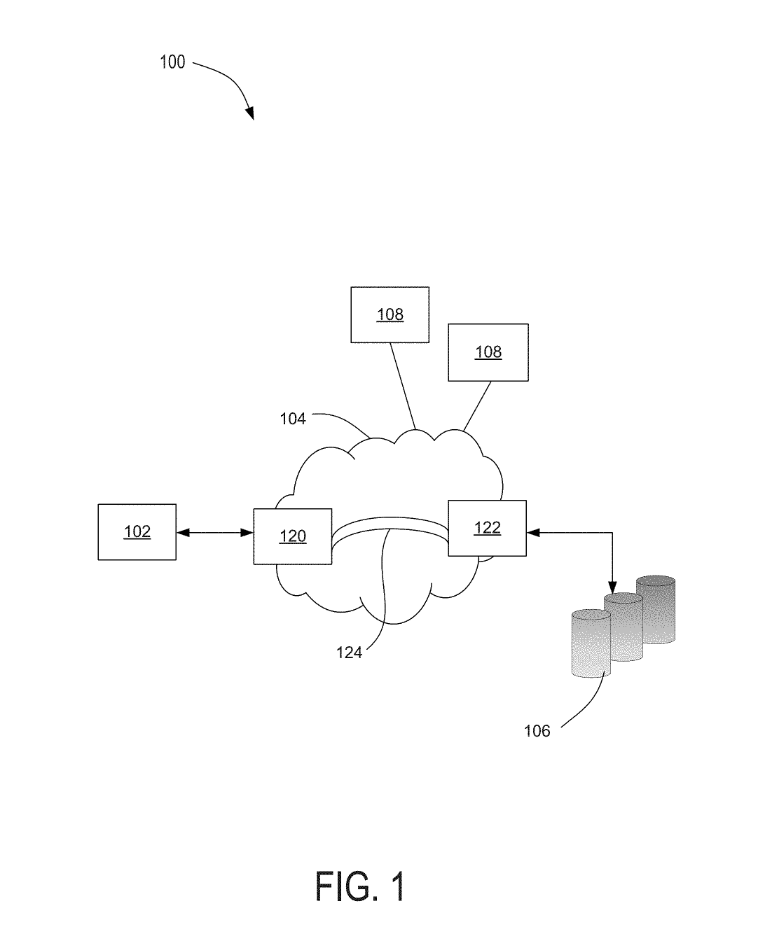

FIG. 1 is a system diagram that illustrates an FCoE VXLAN integrated networking system 100, according to an example. The FCoE VXLAN integrated networking system 100, as shown in FIG. 1, includes a server 102, a VXLAN network 104, a storage network 106, and secondary tenant systems 108.

The server 102 may be a computer system that is configured to transmit and receive FCoE frames. In an example, the server 102 may communicate (e.g., transmit or receive) FCoE frames with the storage network 106 through the VXLAN network 104.

The VXLAN network 104 is a computer network that provides virtualized networking (e.g., as may be provided by a network of VMs hosted on physical devices) and utilizes a Layer 2 overlay scheme over a Layer 3 network. For example, the VXLAN network 104 can extend a L2 virtual network across a L3 network by tunneling the L2 MAC traffic from the individual VMs over the L3 Internet Protocol (IP) core network.

As FIG. 1 shows, the VXLAN network 104 can include VTEPS 120, 122. A VTEP can be a VXLAN endpoint capable of encapsulating VM traffic into an IP tunnel upon ingress and decapsulate VM traffic upon egress. Thus, each individual VM's IP address is hidden to external switches, which mitigates the MAC address overflow issue on physical switches. In some cases, each encapsulated packet carries a 24 bit VXLAN ID, and, as a result, the VM traffic can be classified, in such as case, into about 16 million partition domains.

In some examples, a COS lane 124 connects the VTEP 120, 122 to transmit VXLAN data within the VXLAN network 104. The COS lane 124 may, in some examples, be reserved to communicate FCoE data through the VXLAN network 104. A COS lane refers to a logical link over a physical link. Ethernet frames may include a field, a 802.1Q COS field, for example, that specifies a COS lane that the Ethernet frame is to be communicated through. COS lanes allow flow control on a logical level rather than on at physical connection level.

The storage network 106 may be a dedicated network that provides access to data storage, such as a SAN which provides consolidated, block level data storage. SANS can be used to enhance storage devices, such as disk arrays, tape libraries, and optical jukeboxes, accessible to the server 102 so that the storage devices appear like locally attached storage devices to the operating system. A SAN typically has its own network of storage devices. In some cases, a file system can be built on top of SANs to provide file-level access. In these cases, the storage network 106 is referred to as SAN file systems or shared disk file systems.

Secondary tenant systems 108 may be computer systems that communicate network data through the VXLAN network 104. When the network data from the secondary tenant systems 108 are communicated through the VXLAN network 104, the VXLAN network 104 provides data separation for each of the secondary tenant systems 108.

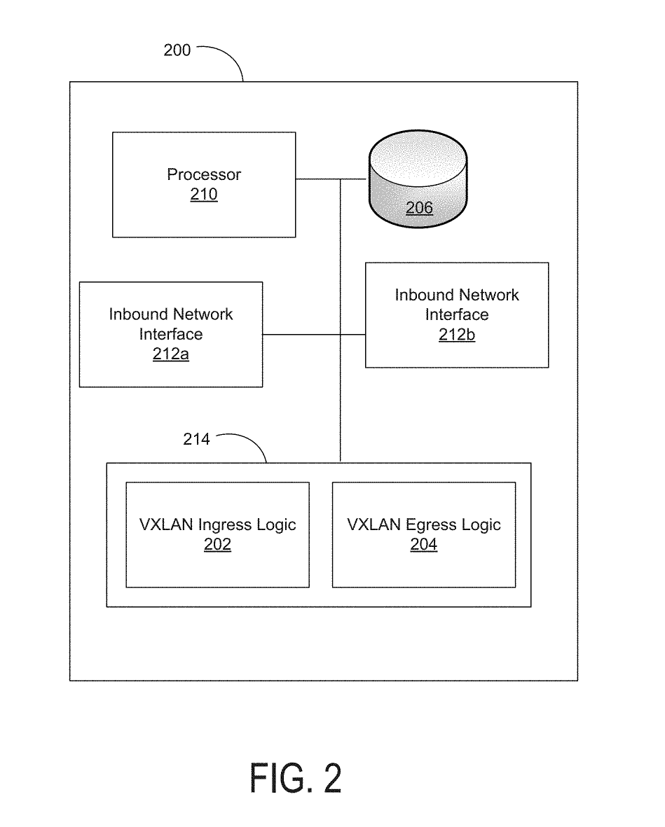

The VTEPS 120, 122 are now described in greater detail. FIG. 2 is a block diagram illustrating a computing device 200 that may implement a VTEP, according to an example. The computing device may include a processor 210, an inbound network interface 212a, an outbound network interface 212b, a forwarding engine 214, and encapsulation policies 206.

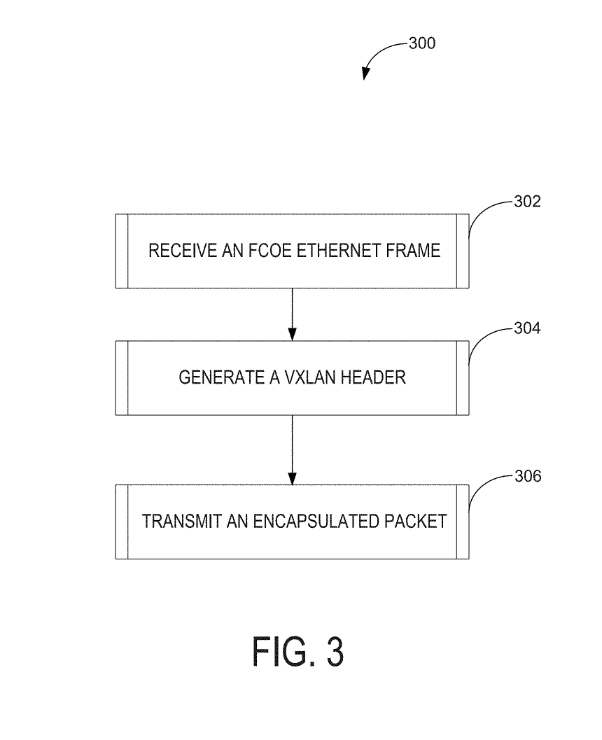

The processor 210 may be, a central processing unit (CPU), a semiconductor-based microprocessor, a graphics processing unit (GPU), or any other hardware devices suitable for retrieval and execution of instructions that configure the forwarding engine 214. For example, the processor 210 may include multiple cores on a chip, include multiple cores across multiple chips, multiple cores across multiple devices, or combinations thereof. The processor 210 may configure the forwarding engine 214 to implement methods and operations discussed below, with reference to FIGS. 3-6. As an alternative or in addition to retrieving and executing instructions, processor 210 may include at least one integrated circuit (IC), other control logic, other electronic circuits, or combinations thereof that include a number of electronic components for configuring the forwarding engine 214 to perform the functionality of the described herein. In some cases, configuring the forwarding engine 214 may involve the processor 210 extracting the policies defined by the encapsulation policies 206 and configuring the forwarding engine 214 to execute those policies.

The inbound network interface 212a may be logic or hardware suitable for receiving data (e.g., FCoE frames or IP packets) entering the computing device 200. The inbound network interface 212a may, in some cases (e.g., where the computer device 200 represents the VTEP 120), be configured to receive and transmit incoming FCoE frames to a VXLAN ingress logic 202. The inbound network interface 212a may, in other cases (e.g., where the computer device 200 represents the VTEP 122), be configured to receive and transmit incoming FCOE frames to the VXLAN ingress logic 202.

The outbound network interface 212b may be logic or hardware suitable for transmitting data (e.g., FCoE frames or IP packets) exiting the computing device 200. The outbound network interface 212b may, in some cases (e.g., where the computer device 200 represents the VTEP 120), be configured to transmit VXLAN packets to the VXLAN network 104. The outbound network interface 212b may, in other cases (e.g., where the computer device 200 represents the VTEP 122), be configured to transmit outgoing FCoE frames destined for the storage network 106.

The forwarding engine 214 may include circuits, such as application specific integrated circuits (ASICs), for integrating FCoE frames on a VXLAN. For example, the forwarding engine 214 may include VXLAN ingress logic 202 and VXLAN egress logic 204. The VXLAN ingress logic 202 may include an integrated circuit (IC), other control logic, other electronic circuits, or combinations thereof that include a number of electronic components to encapsulate incoming FCoE frames (as may be received from either the server 102 or the storage network 106) so that lossless transmission is maintained as the FCoE frames are communicated through the VXLAN network 104. For example, in some cases, the VXLAN ingress logic 202 may be configured to generate a VXLAN message that encapsulates a FCoE frame, where the VXLAN message includes a header with a 802.1Q COS field. The VXLAN ingress logic 202 may encode the value of the 802.1Q COS field in the VXLAN header according to a value of a 802.1Q COS field found in the FCoE frame.

The VXLAN egress logic 204 may be an integrated circuit (IC), control logic, electronic circuits, or combinations thereof that include a number of electronic components to receive VXLAN packets from within the VXLAN network 104 and transmit FCoE frames to devices residing outside of the VXLAN network 104, such as the server 102 or the storage network 106. In some cases, the VXLAN egress logic 204 may generate a FCoE frame with a header that includes a 802.1Q COS field that stores a value based on 802.1Q COS field found in the header of a VXLAN packet.

The encapsulation policies 206 may be data or logic that expresses an encoding policy for generating 802.1Q COS fields in VXLAN headers and inner Ethernet headers at ingress and egress points. For example, the encapsulation policies 206 may include an encoding function that generates an 802.1Q COS field for a VXLAN header based on a value stored in the 802.1Q COS field of an inner Ethernet header of an Ethernet frame being transmitted from the server 102 to the storage network 106. As a further example, the encapsulation policies 206 may include an encoding function that generates an 802.1Q COS field for an Ethernet frame leaving the VXLAN network 104, where the generated 802.1Q COS field is based on a value of an 802.1Q COS field in the VXLAN header.

FIG. 3 is a flowchart of a method 300 for imposition of an encapsulated packet, according to an example, according to an example. For example, imposition of an encapsulated packet may involve encoding a VXLAN 802.1Q COS field based on an Ethernet 802.1Q COS field. The method 300 may be performed by the modules, logic, components, or systems shown in FIGS. 1 and 2 and, accordingly, is described herein merely by way of reference thereto. It is be appreciated that the method 300 may, however, be performed on any suitable hardware.

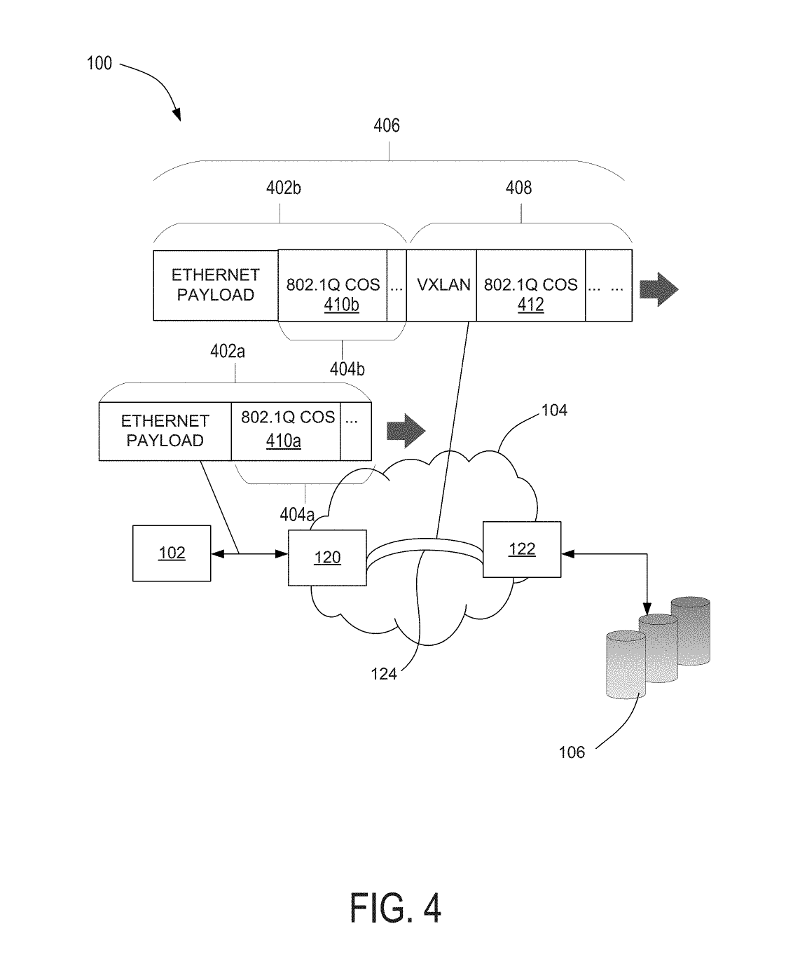

By way of example and not limitation, the method 300 of FIG. 3 is described with further reference to FIG. 4. FIG. 4 is a block diagram illustrating data flow between the server 102, the VXLAN network 104, and the storage network 106, and modules thereof, according to an example.

At operation 302, the VXLAN ingress logic 202 on the VTEP 120 may receive an FCoE Ethernet frame. With momentary reference to FIG. 4, an example of operation 302 is illustrated via the FCoE Ethernet frame 402a being transmitted from the server 102 to the VTEP 120. As FIG. 4 shows, the FCoE Ethernet frame 402a may include a payload (e.g., a Fibre Channel frame) and header data 404a. The header data 404a may include a 802.1Q COS field 410a (which may be a subfield within a 802.1Q tag field). The 802.1Q COS field may specify class of service. For example, 802.1Q COS field 410a may be a 3-bit field that is present in an Ethernet frame header when 802.1Q VLAN tagging is present. The field can specify a priority value between 0 and 7, also referred to as CS0 through CS7, that can be used by quality of service (QoS) disciplines to differentiate and shape/police network traffic. COS can operate on 802.1Q VLAN Ethernet at the data link layer (layer 2) to provide lossless transmission, where the CS0 through CS7 may each specify one of eight virtual links (e.g., COS lanes) that share are shared on a physical Ethernet link.

At operation 304 of FIG. 3, upon receiving the FCoE Ethernet frame, the VXLAN ingress logic 202 may then generate a VXLAN header that encapsulates the FCoE Ethernet frame. In some cases, the VXLAN header may include an 802.1Q COS field. The VXLAN ingress logic 202 may in some cases, as part of operation 304, map and encode the FCoE Ethernet frame's 802.1Q COS field to the 802.1Q COS field in the VXLAN header. The encoding used in operation 304 may be performed according to an encoding function stored in the encapsulation policies 206. In encapsulating the FCoE Ethernet frame, the VXLAN ingress logic 202 may insert frames that include the VXLAN header before the frames of the FCoE Ethernet frame. The segments of the FCoE Ethernet frame and the VXLAN header may each include a reference to a next segment. The references may be traversed to identify the order in which the segments are to be communicated. Thus, generating the encapsulated packet may involve updating a beginning segment pointer to the segments for the VXLAN header and updating the last segment of the VXLAN header to point to the first segment of the FCoE Ethernet frame. In other embodiments, the combining the segments of a frame may be implemented in hardware, such as using content addressable memory (CAM) or ternary CAM (TCAM).

FIG. 4 illustrates an example of the operation 304 through the encapsulated packet 406 being transmitted through the VXLAN network 104. As shown in FIG. 4, the encapsulated packet 406 includes an inner FCoE Ethernet frame 402b, which in turn includes an inner 802.1Q COS field 410b within an inner FCoE header data 404b. The encapsulated packet 406 also includes a 802.1Q COS field 412 in the VXLAN header 408. The VXLAN header 408 may be data or logic used in the VXLAN protocol which transports the encapsulated packet 406 throughout the VXLAN network 104. The value of the 802.1Q COS field 412 may be determined by the VXLAN ingress logic 202 based on an encoding function stored in the encapsulation policies 206. The encoding function may map the value of the 802.1Q COS field 410a to the 802.1Q COS field 412. The values of the 802.1Q COS field 410a and the 802.1Q COS field 412 may differ depending on the encoding function.

At operation 306 of FIG. 3, the VXLAN ingress logic 202 may transmit an encapsulated packet through the VXLAN network 104. It is to be appreciated that in some cases, the encapsulated packet may be communicated through a COS lane reserved for FCoE communication. Further, the encapsulated packet may be communicated according an order specified by frames referenced to each other.

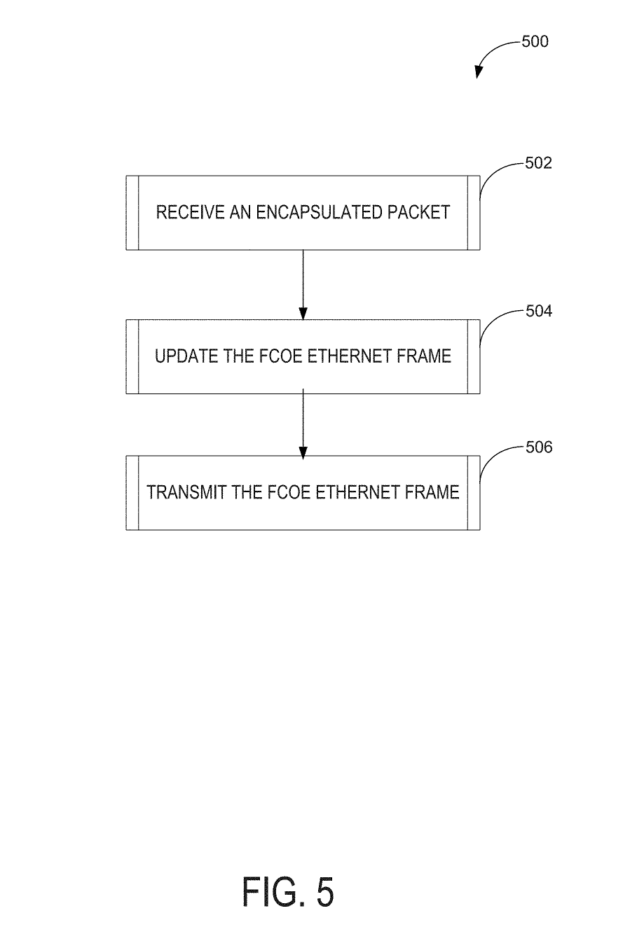

FIG. 5 is a flowchart of a method 500 for disposition of an encapsulated packet, according to an example. Disposition of the encapsulated packet may include encoding a FCoE 802.1Q COS field based on a VXLAN 802.1Q COS field. The method 500 may be performed by the modules, logic, components, or systems shown in FIGS. 1 and 2 and, accordingly, is described herein merely by way of reference thereto. It will be appreciated that the method 500 may, however, be performed on any suitable hardware.

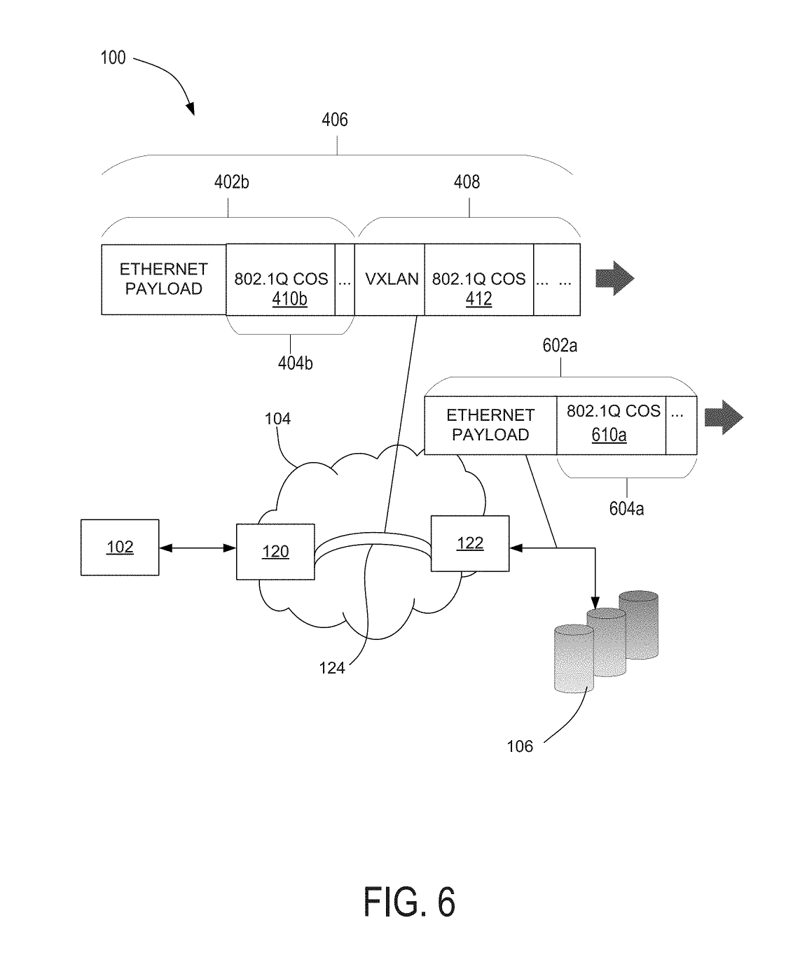

By way of example and not limitation, the method 500 of FIG. 5 is described with further reference to FIG. 6. FIG. 6 is a block diagram illustrating data flow between the server 102, the VXLAN network 104, and the storage network 106, and modules thereof, according to an example.

At operation 502, the VXLAN egress logic 204 on the VTEP 122 may receive an encapsulated packet. With momentary reference to FIG. 6, an example of operation 502 is illustrated via the encapsulated packet 406 being transmitted from the VTEP 120 to the VTEP 122. The encapsulated packet 406 may be transmitted on a COS lane reserved for FCoE traffic, for example.

At operation 504 of FIG. 5, upon receiving the encapsulated packet, the VXLAN egress logic 204 may update the header of a FCoE frame encapsulated within the encapsulated packet. In some cases, the outer header of the encapsulated packet may include an 802.1Q COS field. The VXLAN egress logic 204 may, in some cases, as part of operation 504, map and encode the encapsulated packet's 802.1Q COS field to the 802.1Q COS field in the resulting FCoE frame. The encoding used in operation 504 may be performed according to an encoding function stored in the encapsulation policies 206. In some cases, the 802.1Q COS field 610a may include a value that is different than the value stored in the FCoE frame originally sent into the VXLAN network 104. In some cases, operation 504 may involve the VXLAN egress logic 204 splitting or decapsulating the VXLAN header from the FCoE Ethernet frame. Such splitting may involve the VXLAN egress logic 204 updating the references in the segments of the encapsulated packets such that the VXLAN header are removed from the reference chain connecting the segments of the encapsulated packet.

FIG. 6 illustrates an example of the operation 504 through the FCoE Ethernet frame 602a being generated based on the encapsulated packet 406. In some case, the fields of the FCoE Ethernet frame 602a are generated based on the fields in the inner FCoE Ethernet frame 402b in the encapsulated packet 406. To maintain lossless frame communication, the VXLAN egress logic 204 may encode the value of the 802.1Q COS field 412 in the VXLAN header 408 to the 802.1Q COS field 610a field in the header data 604a of the FCoE Ethernet frame 602a. The value of the 802.1Q COS field 610a may be determined by the VXLAN egress logic 204 based on a decoding function stored in the encapsulation policies 206.

With reference back to FIG. 5, at operation 506, the VXLAN egress logic 204 may transmit the FCoE frame to the storage network 106. The storage network 106 may then process the payload of the FCoE frame to perform block data operations, as an example.

It is to be appreciated that approaches described herein may have many practical advantages. For example, a FCoE VXLAN integration system may be used to provide lossless layer 2 communication through an overlay network such as a VXLAN network, which may use a layer 3 tunnel between layer 2 clients. Further, the encapsulation policies 206 may be used to provide flexibility in defining class of services between a server, an overlay network, and a storage network. For example, using an encapsulation policy, the 802.1Q COS field in the Ethernet frame that is transmitted to the overlay network may differ from the 802.1Q COS field in the Ethernet frame that is transmitted out of the overlay network.

As used herein, the term “computer system” may refer to one or more computer devices, such as the computer device 200 shown in FIG. 2. Further, the terms “couple,” “couples,” “communicatively couple,” or “communicatively coupled” is intended to mean either an indirect or direct connection. Thus, if a first device, module, or engine couples to a second device, module, or engine, that connection may be through a direct connection, or through an indirect connection via other devices, modules, or engines and connections. In the case of electrical connections, such coupling may be direct, indirect, through an optical connection, or through a wireless electrical connection.

Although some examples described herein refer specifically to FCoE frames, it is to be appreciated that some examples may operation on any layer 2 frame that includes fields that specify a lossless control flow. Further, although some examples described herein refer specifically to VXLAN packets that encapsulate FCoE frames (or any other suitable layer 2 frame), it is to be appreciated that some examples may operate on any overlay network that encapsulates a layer 2 frame in a layer 3 packet.

What is claimed is:

1. A method comprising:
receiving, by a virtual extensible local area network (VXLAN) tunnel endpoint (VTEP), an Ethernet frame, the Ethernet frame including a header with a first class of service field;
generating an encapsulated packet, the encapsulated packet including a header with a second class of service field, the generating including encoding the second class of service field based on the first class of service field; and
transmitting the encapsulated packet through a tunnel in a VXLAN network, the VXLAN network communicating the encapsulated packet according to a class of service lane specified by the second class of service field.

2. The method of claim 1, wherein the Ethernet frame is communicated according to a Fibre Channel over Ethernet protocol.

3. The method of claim 1, wherein the first class of service field and the second class of service field map to the same value according to an encapsulation policy of the VTEP.

4. The method of claim 1, wherein the first class of service field and the second class of service field map to different values according to an encapsulation policy of the VTEP.

5. The method of claim 1, wherein the class of service lane specified by the second class of service field is reserved for communicating Fibre Channel over Ethernet received at the VTEP.

6. A computer device comprising:
a circuit to:
receive an encapsulated packet from a tunnel in a virtual extensible local area network (VXLAN), the encapsulated packet including a header with a first class of service field and an Ethernet frame;
update the Ethernet frame, the updated Ethernet frame including a header with a second class of service field, the circuit to update the Ethernet frame by encoding the second class of service field based on the first class of service field; and
transmit the Ethernet frame to a storage network, the storage network providing lossless communication via a class of service lane specified by the second class of service field.

7. The computer device of claim 6, wherein the Ethernet frame is communicated according to a Fibre Channel over Ethernet protocol.

8. The computer device of claim 6, wherein the first class of service field and the second class of service field map to the same value according to an encapsulation policy.

9. The computer device of claim 6, wherein the first class of service field and the second class of service field map to different values according to an encapsulation policy.

10. The computer device of claim 6, wherein the class of service lane specified by the second class of service field is reserved for communicating Fibre Channel over Ethernet received at the computer device.

11. A computer device comprising:
a circuit to:
receive a layer 2 frame specifying a lossless, flow control protocol, the layer 2 frame including a identifying a first class of service lane;
generate a layer 3 packet that encapsulates the layer 2 frame, the layer 3 packet including a layer 3 header that specifies a second class of service lane, the processer to generate the layer 3 by encoding the second class of service lane based on the first class of service lane; and
transmit the layer 3 packet through a tunnel in an overlay network, the overlay network communicating the layer 3 packet according to the second class of service lane.

12. The computer device of claim 11, wherein the layer 2 frame is communicated according to a Fibre Channel over Ethernet protocol.

13. The computer device of claim 11, wherein the first class of service lane and the second class of service lane map to the same value according to an encapsulation policy.

14. The computer device of claim 11, wherein the first class of service lane and the second class of service lane map to different values according to an encapsulation policy.

15. The computer device of claim 11, wherein the second class of service lane is reserved for communicating Fibre Channel over Ethernet frames.
